(19) United States
(12) Patent Application Publication
(10) Pub. No.: US 2026/0153995 A1
(43) Pub. Date: Jun. 4, 2026

(54) STORAGE DEVICE PROVIDING MULTIPLE LOGICAL TO PHYSICAL MAPPING AND OPERATION METHOD THEREOF

(71) Applicant: SAMSUNG ELECTRONICS CO., LTD., Suwon-si (KR)

(72) Inventors: Unseon CHO, Suwon-si (KR); Joonyong Jeong, Suwon-si (KR)

(73) Assignee: SAMSUNG ELECTRONICS CO., LTD., Suwon-si (KR)

(21) Appl. No.: 19/308,762

(22) Filed: Aug. 25, 2025

(30) Foreign Application Priority Data
Dec. 3, 2024 (KR) 10-2024-0177529

(51) Int. Cl. G06F 3/06

(52) U.S. Cl. CPC G06F 3/0611; G06F 3/064; G06F 3/0659; G06F 3/0679

(57) ABSTRACT

Provided is a storage controller for controlling a non-volatile memory device, the storage controller including: memory storing instructions; and a processor configured to execute the instructions and cause the storage controller to: based on a request received from a host indicating a sequential operation, identify a type of a mapping entry between a logical address included in the request and a physical address of the non-volatile memory device; manage a first mapping table including one or more mapping entries of a first type; and manage a second mapping table including one or more mapping entries of a second type, wherein the one or more mapping entries of the first type correspond to data of a first capacity, and wherein the one or more mapping entries of the second type correspond to data of a second capacity.

### CROSS-REFERENCE TO RELATED APPLICATION

This application claims priority to Korean Patent Application No. 10-2024-0177529 filed on Dec. 3, 2024, in the Korean Intellectual Property Office, the disclosure of which is incorporated by reference herein in its entirety.

### BACKGROUND

### 1. Field

The present disclosure relates to a semiconductor memory device, and more particularly, to a storage device providing multiple logical-to-physical (L2P) mapping and an operating method thereof.

### 2. Description of Related Art

Data writing or reading operations of a solid-state drive (SSD) device may be performed based on mapping or conversion operations between logical addresses and physical addresses. The SSD device may store the mapping between logical addresses and physical addresses in a non-volatile memory device, may configure mapping information in the volatile memory device, and then may use the mapping information.

As the capacity of the SSD device increases, the size of address mapping data increases, and thus this may require expansion of the size of the volatile memory space. However, there are some constraints on the size of memory space capable of being provided for address space mapping. Accordingly, a device and a method for efficiently managing a mapping table of the SSD device are required.

### SUMMARY

Provided is a storage device for providing multiple L2P mapping that may efficiently store data based on a method of mapping between logical address and physical address and may efficiently manage storage space, and an operating method thereof.

According to an aspect of the disclosure, a storage controller for controlling a non-volatile memory device includes: a memory storing one or more instructions; and at least one processor configured to individually or collectively execute the one or more instructions, wherein the one or more instructions, when executed by the at least one processor, cause the storage controller to: based on a request received from a host indicating a sequential operation, identify a type of a mapping entry between a logical address included in the request and a physical address of the non-volatile memory device; manage a first mapping table including one or more mapping entries of a first type; and manage a second mapping table including one or more mapping entries of a second type, wherein the one or more mapping entries of the first type correspond to data of a first capacity, and wherein the one or more mapping entries of the second type correspond to data of a second capacity.

According to an aspect of the disclosure, a data write operation method of a storage controller includes: receiving a request and one or more logical addresses from a host; identifying, based on the request, a mapping type between the one or more logical addresses and one or more physical addresses of a non-volatile memory device of the storage controller; generating a mapping entry between the one or more logical addresses and the one or more physical addresses; updating a relationship between types of the mapping entry; and writing data to a physical address included in the mapping entry.

According to an aspect of the disclosure, a storage device includes: a non-volatile memory device configured to store data; and a storage controller configured to control the non-volatile memory device, wherein the storage controller includes: a memory storing one or more instructions; and at least one processor configured to individually or collectively execute the one or more instructions, wherein the one or more instructions, when executed by the at least one processor, cause the storage controller to: receive a request and one or more logical addresses from a host; and identify, based on the request, a type of a mapping entry between the one or more logical addresses and a physical address of the non-volatile memory device, and wherein the mapping entry includes a first type mapping entry corresponding to data of a first capacity and a second type mapping entry corresponding to data of a second capacity.

According to an aspect of the disclosure, a storage controller controlling a non-volatile memory device includes: a memory storing one or more instructions; and at least one processor configured to individually or collectively execute the one or more instructions, wherein the one or more instructions, when executed by the at least one processor, cause the storage controller to: based on a request from a host indicating a sequential operation, identify a type of a mapping entry between a logical address included in a request and a physical address of the non-volatile memory device; and manage a mapping table including one or more mapping entries, wherein the mapping table is configured to identify a type of the mapping entry of the logical address, wherein the mapping table further includes: a first type mapping region including one or more first type mapping entries corresponding to data of a first capacity; and a second type mapping region including one or more second type mapping entries corresponding to data of a second capacity.

According to an aspect of the disclosure, a data write operation method of a storage controller includes: receiving a request and one or more logical addresses from a host; identifying, based on the request, a mapping type between the one or more logical addresses and one or more physical addresses of a non-volatile memory device of the storage controller; updating a mapping entry included in a mapping region; updating a relationship between the one or more logical addresses and a type of the mapping entry corresponding to the one or more logical addresses; and writing data to a physical address included in the mapping entry.

According to an aspect of the disclosure, a storage device includes: a non-volatile memory device configured to store data; and a storage controller configured to control the non-volatile memory device, wherein the storage controller includes: a memory storing one or more instructions; and at least one processor configured to individually or collectively execute the one or more instructions, wherein the one or more instructions, when executed by the at least one processor, cause the storage controller to: receive a request and one or more logical addresses from a host; and identify, based on the request, a type of a mapping entry between the one or more logical addresses and a physical address of the non-volatile memory device, wherein the mapping entry includes a first type mapping entry corresponding to data of a first capacity and a second type mapping entry corresponding to data of a second capacity.

### BRIEF DESCRIPTION OF DRAWINGS

The above and other aspects and features of certain embodiments of the present disclosure will become more apparent from the following description taken in conjunction with the accompanying drawings, in which:

FIG. 1 is a block diagram showing a storage system, according to one or more embodiments of the present disclosure;

FIG. 2 is a block diagram showing an example of the storage controller of FIG. 1, according to one or more embodiments of the present disclosure;

FIG. 3 is a block diagram showing the non-volatile memory device of FIG. 1, according to one or more embodiments of the present disclosure;

FIG. 4 is a block diagram showing an example in which a storage controller manages storage space, according to one or more embodiments of the present disclosure;

FIG. 5A is a block diagram showing an example of a mapping table of the flash translation layer (FTL) block of FIG. 2, according to one or more embodiments of the present disclosure;

FIG. 5B is a block diagram showing an example of mapping tables of the FTL block of FIG. 2, according to one or more embodiments of the present disclosure;

FIG. 6 is a block diagram showing an example of the mapping table of FIG. 5A, according to one or more embodiments of the present disclosure;

FIG. 7 is a block diagram showing an example of the mapping table of FIG. 5A, according to one or more embodiments of the present disclosure;

FIG. 8 is a block diagram showing an example of the mapping table of FIG. 5A, according to one or more embodiments of the present disclosure;

FIG. 9 is a flowchart showing an example of a data write operation method of a storage controller, according to one or more embodiments of the present disclosure;

FIG. 10 is a flowchart showing an example of a data read operation method of a storage controller, according to one or more embodiments of the present disclosure;

FIG. 11 is a flowchart showing an example in which a storage controller updates a mapping table, according to one or more embodiments of the present disclosure; and

FIG. 12 is a block diagram illustrating a system, according to one or more embodiments of the present disclosure.

### DETAILED DESCRIPTION

Hereinafter, embodiments of the present disclosure may be described in detail to such an extent that an ordinary one in the art may implement the present disclosure.

As used throughout the detailed description, components described with reference to the terms “˜unit”, “module”, “block”, “˜er or ˜or”, “circuit or circuitry”, or the like and function blocks illustrated in drawings will be implemented with software, hardware, or a combination thereof. In one or more embodiments, the software may be or include machine codes, firmware, embedded codes, source codes, application software, and/or combinations thereof. In one or more embodiments, the hardware may be or include an electrical circuit, an electronic circuit (an analog circuit or a digital circuit), a processor, a computer, an integrated circuit, integrated circuit cores, a pressure sensor, an inertial sensor, a microelectromechanical system (MEMS), a passive element, and/or a combination thereof. As used herein, a plurality of “units”, “modules”, “members”, and “blocks” may be implemented as a single component, or a single “unit”, “module”, “member”, and “block” may include a plurality of components.

It will be understood that when an element is referred to as being “connected” with or to another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

As used herein, the expressions “at least one of a, b or c” and “at least one of a, b and c” indicate “only a,” “only b,” “only c,” “both a and b,” “both a and c,” “both b and c,” and “all of a, b, and c.”

It will be understood that, although the terms “first”, “second”, “third”, etc., may be used herein to describe various elements, is the disclosure should not be limited by these terms. These terms are only used to distinguish one element from another element.

As used herein, the singular forms “a,” “an” and “the” are intended to include the plural forms as well, unless the context clearly indicates otherwise.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

The various actions, acts, blocks, steps, or the like in the flow diagrams may be performed in the order presented, in a different order, or simultaneously. Further, in one or more embodiments, some of the actions, acts, blocks, steps, or the like may be omitted, added, modified, skipped, or the like without departing from the scope of the disclosure.

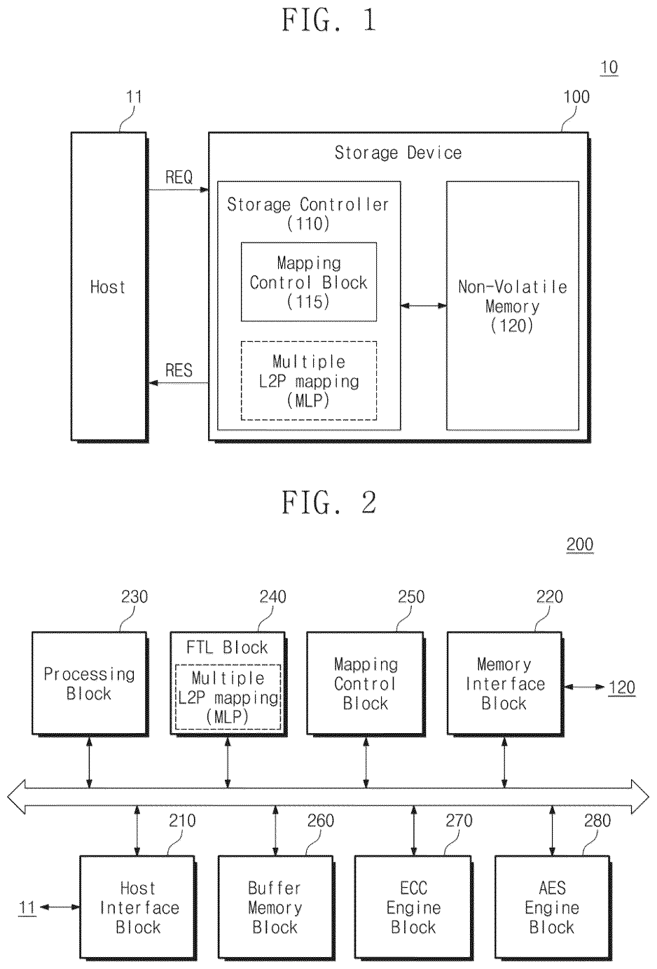

FIG. 1 is a block diagram showing a storage system, according to one or more embodiments of the present disclosure. Referring to FIG. 1, a storage system 10 may include a host 11 and a storage device 100. The storage system 10 may store data and may manage the stored data.

In one or more embodiments, the storage system 10 may be included in various systems or devices. For example, the storage system 10 may be or be included in a system such as a computing system, a communication system, an automotive system, or a cloud system. For another example, the storage system 10 may be included in an electronic device such as a laptop computer, a tablet PC, a personal digital assistant (PDA), a wearable device, or a camera, but the above-described devices are examples and the scope of the present disclosure is not limited thereto.

The host 11 may perform various operations on the storage system 10. In one or more embodiments, the host 11 may be or be implemented as a processor or SoC. For example, the host 11 may be a processor, such as a central processing unit (CPU) or an application processor (AP), or an SoC. In one or more embodiments, the host 11 may execute applications, source codes, programs, or the like. For example, the host 11 may execute the applications through the processor or the SoC, and may perform operations indicated by the applications.

The host 11 may read out data required for an operation from the storage device 100, or may store data generated by the operation in the storage device 100. The host 11 may send, to the storage device 100, a request REQ indicating an operation to be performed by the storage device 100 or including the operation. The host 11 may receive, from the storage device 100, a response RES corresponding to data or an operation performed by the storage device 100. The host 11 may send, to the storage device 100, the request REQ indicating a data write or read operation. In one or more embodiments, the host 11 may receive, from the storage device 100, the response RES corresponding to the completion of data write, or the response RES indicating completion of data read and including the read data.

In one or more embodiments, the host 11 may include a buffer that stores data. For example, the host 11 may include a buffer (or a buffer memory), such as a static random access memory (SRAM) or a dynamic RAM (DRAM), and may temporarily store data in the buffer, or store the source code to be executed, or the executable file of an application. The host 11 may generate data to be written to the storage device 100, based on the above-described operations. In one or more embodiments, the request REQ or the response RES may have a format conforming to any standard (e.g., a serial advanced technology attachment (SATA) protocol, universal flash storage (UFS) protocol, or the like).

The storage device 100 may store data of the storage system 10. Referring to FIG. 1, the storage device 100 may include a storage controller 110 and a non-volatile memory device 120. The storage controller 110 may include a mapping control block 115 and may support multiple L2P mapping (MLP).

The storage controller 110 may control overall operations of the storage device 100. In one or more embodiments, the storage controller 110 may allow the non-volatile memory device 120 to perform an operation corresponding to the request REQ received from the host 11 by the storage device 100. For example, the storage controller 110 may generate a command corresponding to the request REQ indicating data write and may control the non-volatile memory device 120.

The storage device 100 may generate address mapping between a logical address of the host 11 and a physical address of a non-volatile device of the storage device 100, and may store data based on the address mapping. As the capacity of the non-volatile memory device of the storage device 100 increases, the capacity of a memory (e.g., a volatile memory) required for the address mapping may increase. As the capacity of non-volatile memory devices increases, the memory space for the address mapping is incapable of being expanded (e.g., physically) without constraints, thereby requiring devices and methods for more efficiently creating and managing the address mapping.

The mapping control block 115 may determine the type of mapping (L2P mapping) between the logical address of the host 11 and the physical address of the non-volatile memory device 120 in response to the request REQ. In one or more embodiments, the mapping control block 115 may determine the type of L2P mapping based on the request REQ. For example, the mapping control block 115 may determine the L2P mapping type based on whether the request REQ indicates a sequential operation. For another example, the mapping control block 115 may determine the L2P mapping type based on whether the request REQ indicates a random operation. For example, under the control of the mapping control block 115, first type L2P mapping may be generated when the operation indicated by the request REQ received by the storage controller 110 is a random write operation, and second type L2P mapping may be generated when the request REQ indicates a sequential write.

The multiple L2P mapping MLP may include or indicate L2P mapping of one or more types. In one or more embodiments, respective L2P mapping of the plurality of types may have a different size (or capacity) of data indicated by one L2P mapping entry for each type. For example, the first type L2P mapping may indicate 4 KB of data for each L2P mapping entry, and the second type L2P mapping may indicate 16 KB of data for each L2P mapping entry. In this case, the size of data indicated by four first type L2P mapping entries may be the same as the size of data indicated by one second type L2P mapping entry.

In one or more embodiments, the one type of L2P mapping may be managed such that it does not exceed an arbitrary ratio of the total mapping space. For example, the multiple L2P mapping MLP may be managed such that a ratio of first type L2P mapping space to the total mapping space does not exceed 80% (i.e., a ratio of the number of first type L2P mapping entries to the total number of allocable mapping entries may not exceed 80%.). The size of the memory space indicated by each first type L2P mapping entry and the size of the memory space indicated by each second type L2P mapping entry are examples and should not be construed as limiting the scope of the present disclosure. For example, one or more embodiments in which the first type L2P mapping entry indicates 4 KB of data and the second type L2P mapping entry indicates 16 KB of data may also fall within the scope of the present disclosure.

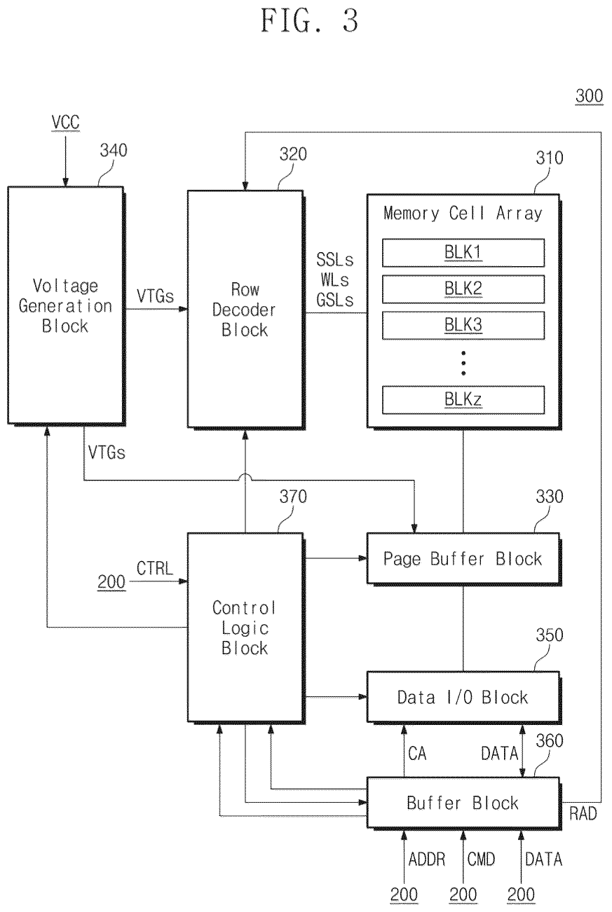

In one or more embodiments, the ratio between the size of data indicated by the first type L2P mapping entry and the size of data indicated by the second type L2P mapping entry may be a power of 2. The mapping control block 115 and the multiple L2P mapping MLP are described in more detail with reference to FIGS. 2 and 5A to 11. The storage controller 110 will be described in more detail with reference to FIG. 2.

Referring to FIG. 1 and the following drawings, the storage device 100 is described as including one storage controller 110 and one non-volatile memory device 120, but the scope of the present disclosure is not limited thereto. In one or more embodiments, the storage device 100 may include one or more storage controllers and one or more non-volatile memory devices. In one or more embodiments, a storage controller may control a plurality of non-volatile memory devices and may generate and manage mapping between logical addresses and physical addresses (of a plurality of non-volatile memory devices). In addition, the storage controller may write data to each of the plurality of non-volatile memory devices or may read data from each of the plurality of non-volatile memory devices. For example, the storage controller 110 may connect the plurality of non-volatile memory devices through a plurality of channels and/or ways, and corresponding ways may operate in response to the same enable signal.

FIG. 2 is a block diagram showing an example of a storage controller of FIG. 1, according to one or more embodiments of the present disclosure. A storage controller 200 may correspond to the storage controller 110 of FIG. 1. Referring to FIG. 2, the storage controller 200 may include a host interface block 210, a memory interface block 220, a processing block 230, a flash translation block (FTL) block 240, a mapping control block 250, a buffer memory block 260, an error correction code (ECC) engine block 270, and an advanced encryption standard (AES) engine block 280.

The host interface block 210 may receive the request REQ from the host 11 of FIG. 1 or may transmit the response RES to the host 11 of FIG. 1. In one or more embodiments, the host interface block 210 may exchange the request REQ or the response RES with the host 11 in a packet form. For example, the host interface block 210 may receive, from the host 11 of FIG. 1, the request REQ corresponding to an operation to be performed by the non-volatile memory device 120 of FIG. 1 or data to be written to the non-volatile memory device 120 of FIG. 1. For another example, the host interface block 210 may transmit the response RES corresponding to the operation performed by the non-volatile memory device 120 of FIG. 1 or data read from the non-volatile memory device 120 of FIG. 1 to the host 11 of FIG. 1. In one or more embodiments, the host interface block 210 may be implemented to comply with a standard protocol, such as a SATA protocol or a UFS protocol.

The memory interface block 220 may transmit data written to the non-volatile memory device 120 of FIG. 1 to the non-volatile memory device 120 of FIG. 1, or may receive data read from the non-volatile memory device 120 of FIG. 1. In one or more embodiments, the memory interface block 220 may be implemented to comply with a standard protocol such as Toggle or Open NAND Flash Interface (ONFI).

The processing block 230 may control overall operations of the storage controller 200. In one or more embodiments, the processing block 230 may be implemented as any processing unit or may include any processing unit. For example, the processing block 230 may be implemented as a central processing unit (CPU), or may include a CPU.

In one or more embodiments, the processing block 230 may allow the storage controller 200 to perform an operation corresponding to the request REQ received from the host 11 of FIG. 1. For example, the processing block 230 may parse a command included in the request REQ and may deliver the parsed result to the non-volatile memory device 120 of FIG. 1 through the memory interface block 220. For another example, the processing block 230 may generate a command corresponding to the request REQ, and may deliver the generated command and data to be written to the non-volatile memory device 120 of FIG. 1 included in the request REQ to the non-volatile memory device 120 of FIG. 1 through the memory interface block 220.

The FTL block 240 may perform several functions such as address mapping, wear-leveling, and garbage collection. The wear-leveling may be implemented through a technology for allowing blocks in the non-volatile memory device 120 of FIG. 1 to be used uniformly such that excessive degradation of a specific block is prevented, for example, a firmware technology for balancing erase counts of physical blocks. The garbage collection refers to a technology for securing an available capacity of the non-volatile memory device 120 of FIG. 1 through a way to erase an existing block after copying valid data of the existing block to a new block. The address mapping operation refers to an operation for translating a logical address received from the host 11 of FIG. 1 into a physical address to be used to actually store data in the non-volatile memory device 120 of FIG. 1.

In one or more embodiments, the FTL block 240 may support the multiple L2P mapping MLP. For example, the FTL block 240 may provide first type L2P mapping and second type L2P mapping. In one or more embodiments, the FTL block 240 may determine an L2P mapping type between a logical address included in the request REQ and a physical address of the non-volatile memory device 120 of FIG. 1, at the request REQ received from the host 11 of FIG. 1.

In one or more embodiments, the FTL block 240 may generate or manage a mapping table for address mapping operations. In one or more embodiments, the mapping table may include mapping entries of a plurality of types. It is described that the FTL block 240 performs an address mapping operation by using the mapping table, but the present disclosure is not limited thereto. For example, the FTL block 240 may implement address mapping or address mapping supporting multiple L2P mapping based on any data structure other than a table structure.

In one or more embodiments, the range of physical addresses included in the first type L2P mapping (or a mapping entry) may be different from the range of physical addresses included in the second type L2P mapping (or a mapping entry). In one or more embodiments, the space where data corresponding to the first type L2P mapping entry is stored and the space where data corresponding to the second type L2P mapping entry is stored may be physically separated from each other. For example, the first storage space where data corresponding to the first type L2P mapping entry is stored may be storage space having a different physical distinction (e.g., a chip, a channel, a way, a plane, or a block) from the second storage space, where data corresponding to the second type L2P mapping is stored.

The mapping control block 250 may determine the type of L2P mapping. The mapping control block 250 may correspond to the mapping control block 115 of FIG. 1. In one or more embodiments, the mapping control block 250 may determine the type of L2P mapping corresponding to the received logical address based on the request REQ. For example, when the request REQ indicates a random operation, the mapping control block 250 may determine the generation of the first type L2P mapping or the first type L2P mapping entry. In one or more embodiments, the mapping control block 250 may control the multiple L2P mapping MLPs based on controlling the FTL block 240.

It is described that the multiple L2P mapping MLP includes two types of L2P mappings or generates two types of L2P mapping entries, but the scope of the present disclosure is not limited thereto. In one or more embodiments, one or more embodiments, the multiple L2P mapping MLP includes three or more types of L2P mappings or generates three or more types of L2P mapping entries. The criteria in which the mapping control block 250 selects or determines the first type L2P mapping or the second type L2P mapping are examples, and the scope of the present disclosure is not limited thereto.

The buffer memory block 260 may store data necessary for the operation of the storage controller 200. In one or more embodiments, the buffer memory block 260 may (temporarily) store a mapping table (e.g., in which the multiple L2P mapping MLP is implemented) generated by the FTL block 240. In one or more embodiments, the processing block 230 may control overall operations of the storage controller 200 based on access to data stored in the buffer memory block 260.

In one or more embodiments, the buffer memory block 260 may temporarily store data, which is to be written to or read from the non-volatile memory device 120 of FIG. 1. For example, the buffer memory block 260 may temporarily store write data included in the request REQ received from the host 11 of FIG. 1, and may provide the write data to the non-volatile memory device 120 of FIG. 1 through the memory interface block 220.

In one or more embodiments, the buffer memory block 260 may include a volatile memory device. For example, the buffer memory block 260 may include a dynamic random access memory (DRAM) device or a static RAM (SRAM) device. In one or more embodiments, the buffer memory block 260 may further include a ROM that stores firmware or codes of the firmware used for the configuration of the storage controller 200.

The ECC engine block 270 may perform error detection and correction functions on read data read from the non-volatile memory device 120 of FIG. 1. In more detail, the ECC engine block 270 may generate parity bits for write data to be written in the non-volatile memory device 120, and the parity bits thus generated may be stored in the non-volatile memory device 120 of FIG. 1 together with the write data. When data are read from the non-volatile memory device 120 of FIG. 1, the ECC engine block 270 may correct an error of the read data by using parity bits read from the non-volatile memory device 120 of FIG. 1 together with the read data and may output the error-corrected read data.

The AES engine block 280 may perform an encryption operation or a decryption operation on data input to the storage controller 200. In one or more embodiments, the AES engine block 280 may perform encryption or decryption operations on received data based on at least one or more of various encryption and/or decryption algorithms, such as a symmetric-key algorithm.

In one or more embodiments, the mapping table may be stored in the non-volatile memory device 120 of FIG. 1 and may be loaded into the buffer memory block 260 depending on the operation of the storage controller 200. For example, when the FTL block 240 performs an address mapping operation, part or all of the mapping table stored in the non-volatile memory device 120 may be loaded into the buffer memory block 260 and may be accessed by the blocks in the storage controller 200. In this case, the mapping table may be implemented with multiple L2P mappings and may include one or more first type L2P mapping entries and one or more second type L2P mapping entries. Alternatively, the mapping table may further include one or more other types of L2P mapping entryies.

In one or more embodiments, the mapping table may be a page mapping table or may include a page mapping table. In one or more embodiments, the mapping table may further include an additional mapping table. For example, the mapping table may be implemented as a multi-level mapping table further including the page mapping table and the additional mapping table. Hereinafter, it is described that the mapping table is the page mapping table, but the scope of the present disclosure should not be understood as being limited thereto. There may be a plurality of mapping tables managed by the FTL block 240 or the mapping control block 250. For example, the FTL block 240 or the mapping control block 250 may generate, change, or manage a first page mapping table and a second page mapping table.

Each of the blocks in FIG. 2 is an example and the scope of the present disclosure is not limited thereto. In one or more embodiments, the storage controller 200 may not include at least some of the blocks described above. The division of each of the blocks in FIG. 2 may be a functional division, and the present disclosure is not limited to each block being implemented physically or in hardware. In one or more embodiments, functions of at least some of the blocks may be performed by other blocks. In one or more embodiments, some or all of functions of the blocks may be performed by other blocks. For example, all or part of the function(s) of at least one of the FTL block 240, the mapping control block 250, the ECC engine block 270, or the AES engine block 280 may be implemented by the processing block 230. For example, the operation of the mapping control block 250 may be defined in firmware stored in the buffer memory block 260 (e.g., a read only memory (ROM) within the buffer memory block 260).

FIG. 3 is a block diagram showing in detail the non-volatile memory device of FIG. 1, according to one or more embodiments of the present disclosure. A non-volatile memory device 300 may correspond to the non-volatile memory device 120 of FIG. 1. Referring to FIG. 3, the non-volatile memory device 300 may include a memory cell array 310, a row decoder block 320, a page buffer block 330, a voltage generation block 340, a data input/output (I/O) block 350, a buffer block 360, and a control logic block 370. The non-volatile memory device 300 according to one or more embodiments of the present disclosure will be described in detail with reference to FIG. 3.

In one or more embodiments, the non-volatile memory device 300 may include memory cells of an arbitrary structure. For example, the non-volatile memory device 300 may include NAND flash memory cells. Hereinafter, for convenience of description, it is described that the non-volatile memory device 300 is a NAND flash memory device, but the scope of the present disclosure is not limited thereto. It should be understood that one or more embodiments in which the non-volatile memory device 300 includes other types of memory cells, such as a ferro-electric random access memory (FeRAM), a magnetic RAM (MRAM), or a spin torque transfer MRAM (STTMRAM), is also within the scope of the present disclosure.

The memory cell array 310 may include a plurality of memory blocks BLK1 to BLKz. Each of the memory blocks BLK1 to BLKz may include a plurality of memory cells. Each of the memory blocks BLK1 to BLKz may be connected to the row decoder block 320 through at least one ground selection line GSL, word lines WLs, and at least one string selection line SSL. Some of the word lines WLs may be used as dummy word lines. Each of the memory blocks BLK1 to BLKz may be connected to the page buffer block 330 through a plurality of bit lines BLs. The plurality of memory blocks BLK1 to BLKz may be commonly connected to the plurality of bit lines BLs.

In one or more embodiments, each of the plurality of memory blocks BLK1 to BLKz may be a unit of an erase operation. The memory cells belonging to each of the memory blocks BLK1 to BLKz may be erased simultaneously. In another embodiment, each of the plurality of memory blocks BLK1 to BLKz may be split into sub-blocks. Each of the plurality of sub-blocks may be a unit of an erase operation, and the plurality of memory cells belonging to each of the sub-blocks may be erased simultaneously. Hereinafter, the erase unit may refer to a unit of an erase operation, and the erase unit may be a memory block or a sub-block.

Each of the memory blocks BLK1 to BLKz may include a plurality of pages. The plurality of pages may be connected to the word lines WLs, respectively. Each of the pages may be a unit of write operation.

Each bit written to each memory cell of one page may form a logical page. For example, when three bits are written to one memory cell, one physical page may include three logical pages. For another example, when one bit is written to one memory cell, one physical page may include one logical page. A logical pages or a physical page may be the unit of a read operation.

The row decoder block 320 may decode a row address RAD received from the buffer block 360 and may control voltages to be applied to the string selection lines SSL, the word lines WLs, and the ground selection lines GSL based on the decoded row address RAD.

The page buffer block 330 may be connected to the memory cell array 310 through the plurality of bit lines BLs. The page buffer block 330 may be connected to the data I/O block 350 through a plurality of data lines DLs. The page buffer block 330 may operate under control of the control logic block 370.

When the non-volatile memory device 300 performs a program operation, the page buffer block 330 may store data to be written to memory cells. The page buffer block 330 may apply a voltage corresponding to each of the plurality of bit lines BLs based on the stored data. When the non-volatile memory device 300 performs a read operation, or performs a verifying read of a program operation or an erase operation, the page buffer block 330 may sense the voltage of each of the bit line BLs and may store the sensed results.

The voltage generation block 340 may generate voltages used for the operation of the non-volatile memory device 300. In one or more embodiments, the voltage generation block 340 may generate a plurality of voltages based on a power supply voltage VCC. For example, the voltage generation block 340 may generate voltages VTGs by converting or processing the power supply voltage VCC and may deliver the generated voltages VTGs to the row decoder block 320 or the page buffer block 330. In one or more embodiments, the voltage generation block 340 may operate under the control from the control logic block 370.

The data I/O block 350 may be connected to the page buffer block 330 through the plurality of data lines DLs. The data I/O block 350 may receive a column address CA from the buffer block 360. The data I/O block 350 may output data read by the page buffer block 330 to the buffer block 360 based on the column address CA. The data I/O block 350 may deliver data received from the buffer block 360 to the page buffer block 330, based on the column address CA.

The buffer block 360 may receive a command CMD or an address value ADDR from an external device (e.g., the storage controller 200 of FIG. 2) and may exchange data DATA with the external device. The buffer block 360 may operate under the control of the control logic block 370. The buffer block 360 may deliver the command CMD to the control logic block 370, may deliver the row address RAD of the address value ADDR to the row decoder block 320, and may deliver the column address CA of the address value ADDR to the data I/O block 350. The buffer block 360 may exchange the data “DATA” with the data I/O block 350.

The control logic block 370 may receive a control signal CTRL through an external device (e.g., the storage controller 200 of FIG. 2). The control logic block 370 may allow the buffer block 360 to route the command CMD, the address value ADDR, and the data DATA. The control logic block 370 decodes the command CMD received from the buffer block 360 and may control the non-volatile memory device 300 according to the decoded command.

In one or more embodiments, the non-volatile memory device 300 may be manufactured in a bonding manner. The memory cell array 310 may be manufactured at a first wafer, and the row decoder block 320, the page buffer block 330, the data I/O block 350, the buffer block 360, and the control logic block 370 may be manufactured at a second wafer. The non-volatile memory device 300 may be implemented by coupling the first wafer and the second wafer such that an upper surface of the first wafer and an upper surface of the second wafer face each other.

In another embodiment, the non-volatile memory device 300 may be manufactured in a cell over peri (COP) manner. A peripheral circuit including the row decoder block 320, the page buffer block 330, the data I/O block 350, the buffer block 360, and the control logic block 370 may be implemented on a substrate. The memory cell array 310 may be implemented over the peripheral circuit. The peripheral circuit and the memory cell array 310 may be connected by using through vias.

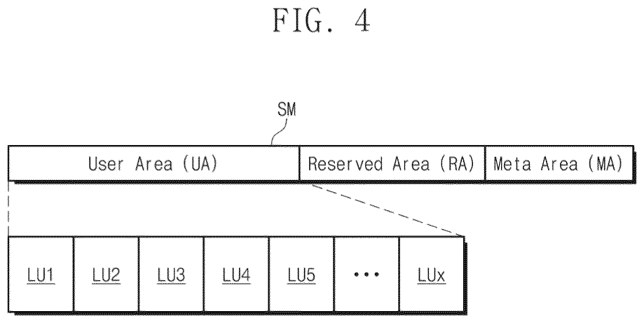

FIG. 4 is a block diagram showing examples, in which the storage controller of FIG. 2 manages storage space SM of the non-volatile memory device of FIG. 3, according to one or more embodiments of the present disclosure. According to embodiments of the present disclosure, embodiments, in which the storage controller 200 manages the storage space SM of the non-volatile memory device 300, are described with reference to FIGS. 2 to 4.

Referring to FIGS. 1 to 4, the storage space SM may include a user area UA, a reserved area RA, and a meta area MA. Each of the user area UA, the reserved area RA, and the meta area MA may include a plurality of erase units.

The storage controller 200 may provide the user area UA as storage space capable of being accessed by the host 11. The storage controller 200 may not provide the reserved area RA to the host 11. In one or more embodiments, the storage controller 200 may use the reserved area RA to improve the performance of the non-volatile memory device 300. For example, the storage controller 200 may use the reserved area RA as a replacement memory for a bad block or a backup memory.

Similarly, the storage controller 200 may not provide the meta area MA to the host 11. In one or more embodiments, the storage controller 200 may store metadata, which is required for the storage device 100 to operate, in the meta area MA. For example, the storage controller 200 may store a mapping table (e.g., where the multiple L2P mapping MLP is implemented) generated or managed by the FTL block 240 in the meta area MA.

The storage controller 200 may split the user area UA into a plurality of logical areas LU1 to LUx (hereinafter, “x” indicates the number of logical areas). Each of the logical areas LU1 to LUx may include one or more memory blocks or erase units. In one or more embodiments, each of the logical areas LU1 to LUx may be allocated to support random write (RW), sequential write (SW), or zone write (ZW).

The storage controller 200 may manage the logical areas LU1 to LUx by using the mapping table. In one or more embodiments, the storage controller 200 may manage the logical areas LU1 to LUx based on the mapping table in which the multiple L2P mapping MLPs are implemented. In one or more embodiments, the type of L2P mapping of each of the logical areas LUI to LUx may be different. For example, data of the first logical area LU1 may be managed by the first type L2P mapping, or data of the second logical area LU2 may be managed by the second type L2P mapping. In one or more embodiments, the storage controller 200 may load and use part or all of the mapping table stored in the meta area MA into the buffer memory block 260.

Embodiments in which the storage controller 200 described through FIG. 4 manages the storage space SM are examples and should not limit the scope of the present disclosure thereto. In one or more embodiments, a shared write booster buffer (SWBB) (of fixed or variable capacity) may be further allocated to the user area UA, or a dedicated write booster buffer (DWBB) (of fixed or variable capacity) used for only a specific logical area may be further allocated to the user area UA. In one or more embodiments, the type of memory cells in a SWBB area may be SLC, and may be utilized as space for SLC backup in a write operation of the storage device 100.

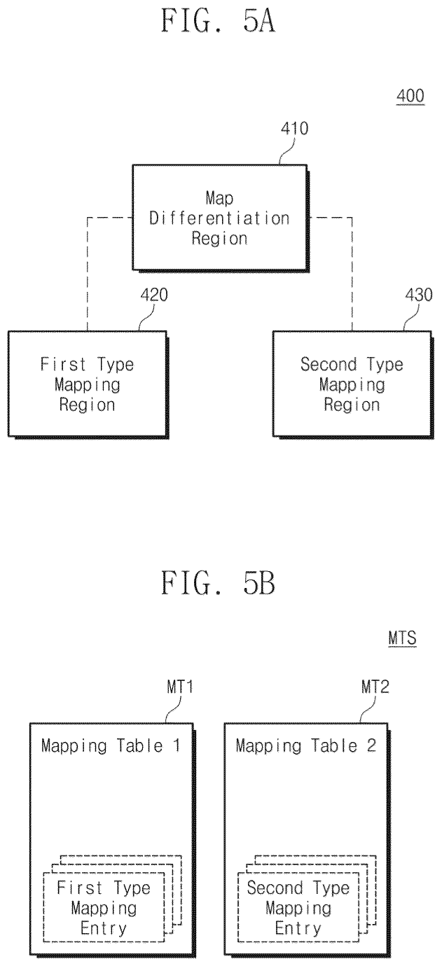

FIG. 5A is a block diagram showing an example of a mapping table, according to one or more embodiments of the present disclosure. A mapping table 400 may correspond to the mapping tables of FIGS. 1 to 4 and implement the multiple L2P mapping MLP of FIG. 2. In one or more embodiments, the mapping table 400 may be managed by the FTL block 240 or the mapping control block 250 of FIG. 2. In one or more embodiments, at least part or all of the mapping table 400 may be stored in the buffer memory block 260 of FIG. 2 or the non-volatile memory device 300 (e.g., the meta area MA of FIG. 4).

In one or more embodiments, the mapping table 400 may have an arbitrary data structure. For example, the mapping table 400 may have a data structure such as a bitmap or a table. In one or more embodiments, the mapping table 400 may include the combination of a plurality of data structures. For example, a first portion of the mapping table 400 may include a bitmap, and a second portion of the mapping table 400 may include a table.

Referring to FIG. 5A, the mapping table 400 may include a map differentiation region 410, a first type mapping region 420, and a second type mapping region 430. Each of the regions of FIG. 5A may be split for ease of description or function, and the present disclosure is not limited thereto. In one or more embodiments, each of the regions of FIG. 5A may include or be implemented as an arbitrary data structure (e.g., a bitmap, a table, or the like).

In FIG. 5A and the following drawings, a logical address may refer to or include an address managed or accessed by a host (e.g., the host 11 of FIG. 1), such as a logical address, a logical block address LBA, or a logical page number LPN. Likewise, the physical address may refer to or include an address for managing a non-volatile memory device (e.g., the non-volatile memory device 120 of FIG. 1) or accessing the non-volatile memory device, such as a physical address, a physical block address, or a physical page number PPN. Hereinafter, it is described that the logical address is a logical page number and the physical address is a physical page number, but it should be understood that the present disclosure is capable of being applied to addresses of other formats.

The map differentiation region 410 may manage the L2P mapping type of each logical address of the host 11 in FIG. 1. In one or more embodiments, the map differentiation region 410 may store or manage L2P mapping type information of logical addresses or type information of L2P mapping entries corresponding to logical addresses. For example, the map differentiation region 410 may manage or store information regarding whether each logical address is included in the first type L2P mapping entry or the second type L2P mapping entry.

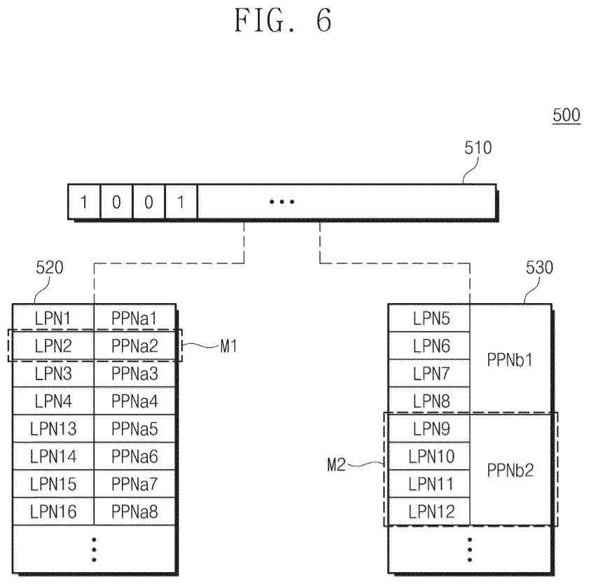

In one or more embodiments, the L2P mapping type of each logical address of the map differentiation region 410 may be determined based on the request REQ of FIG. 1. For example, when the write request REQ received by the storage device 100 indicates random write, the corresponding logical address may be managed based on the first type L2P mapping. For another example, when the request REQ indicates sequential write, the corresponding logical address may be managed based on the second type L2P mapping. In one or more embodiments, the map differentiation region 410 may be implemented with a bitmap structure. However, this is only an example and the scope of the present disclosure is not limited thereto. The map differentiation region 410 will be described in more detail with reference to FIGS. 6 to 9.

Each of the mapping regions 420 and 430 may include one or more mapping entries. In one or more embodiments, each of the mapping entries may include information about the logical address of the host 11 of FIG. 1 and information about the physical address of the non-volatile memory device 300 of FIG. 3. In one or more embodiments, each of the mapping entries may have types corresponding to the mapping regions 420 and 430. For example, a mapping entry in the first type mapping region 420 may be a first type mapping entry, and a mapping entry in the second type mapping region 430 may be a second type mapping entry.

In FIG. 5A and the following drawings, the first type mapping entry may be identical to or similar to the first type L2P mapping entry of FIGS. 1 and 2, or may correspond to the first type L2P mapping entry of FIGS. 1 and 2. The second type mapping entry of FIG. 5A to the following drawings may be identical to or similar to the second type L2P mapping entry of FIG. 1 to FIG. 2 or may correspond to the second type L2P mapping entry of FIG. 1 to FIG. 2.

The first type mapping region 420 may manage first type L2P mapping. The first type mapping region 420 may include or store one or more first type mapping entries. For example, the first type mapping region 420 may manage first type L2P mapping through the first type mapping entry.

In one or more embodiments, the first type mapping entry may indicate or correspond to data of the first capacity. For example, the first type mapping entry may indicate data of 4 KB, but this is an example and the scope of the present disclosure is not limited thereto. In one or more embodiments, the first type mapping region 420 may be implemented based on a table structure, but this is an example and the scope of the present disclosure is not limited thereto. The first type mapping region 420 will be described in more detail with reference to FIGS. 6 to 9.

The second type mapping region 430 may manage second type L2P mapping. The second type mapping region 430 may include or store one or more second type mapping entries. For example, the second type mapping region 430 may manage second type L2P mapping through the second type mapping entry.

In one or more embodiments, the second type mapping entry may indicate or correspond to data of the second capacity. For example, the second type mapping entry may indicate data of 16 KB, but this is an example and the scope of the present disclosure is not limited thereto. In one or more embodiments, the second type mapping region 430 may be implemented based on a table structure, but this is an example and the scope of the present disclosure is not limited thereto. The second type mapping region 430 will be described in more detail with reference to FIGS. 6 to 9.

In one or more embodiments, a ratio of one of the mapping regions 420 and 430 may be managed to be less than a threshold value. For example, the number or capacity of first type mapping entries included in the first type mapping region 420 may be managed to be less than 80% of the maximum number or capacity of allocable mapping entries capable of being included in the mapping table 400. However, this is an example, and the scope of the present disclosure is not limited thereto. In one or more embodiments, the ratio of the mapping regions 420 and 430 may be managed by the mapping control block 250 of FIG. 2. In one or more embodiments, the size or capacity of the first type mapping entry may be (e.g., substantially) the same as the size or capacity of the second type mapping entry.

The mapping table 400 of FIG. 5A is an example and the scope of the present disclosure is not limited thereto. It should be understood that embodiments not including at least some of the described regions are also within the scope of the present disclosure. One or more embodiments in which the mapping table 400 does not include the map differentiation region 410 may also fall within the scope of the present disclosure. In this case, the mapping control block 250 of FIG. 2 may manage mapping entry types and may manage the mapping regions 420 and 430 in which the generated mapping entries are stored.

FIG. 5B is a block diagram showing mapping tables managed by the FTL block of FIG. 2, according to one or more embodiments of the present disclosure. Referring to FIG. 5B, mapping tables MTS may include a first mapping table MT1, and a second mapping table MT2. The mapping tables MTS may implement the multiple L2P mapping MLP of FIGS. 1 and 2. In one or more embodiments, the mapping tables MTS may be managed by the FTL block 240 or the mapping control block 250 of FIG. 2. In one or more embodiments, at least part or all of the mapping tables MTS may be stored in the buffer memory block 260 of FIG. 2 or the non-volatile memory device 300 (e.g., the meta area MA of FIG. 4).

The first mapping table MT1 may include first type mapping entries. In one or more embodiments, the first mapping table MT1 may include the first type mapping entries of FIG. 5A. The first mapping table MT1 may be identical to or similar to the first type mapping region 420 of FIG. 5A.

The second mapping table MT2 may include second type mapping entries. In one or more embodiments, the second mapping table MT2 may include the second type mapping entries of FIG. 5A. The second mapping table MT2 may be identical to or similar to the second type mapping region 430 of FIG. 5A.

The mapping table 400 of FIG. 5A and the mapping tables MTS of FIG. 5B are examples and the scope of the present disclosure is not limited thereto. It should also be understood that one or more embodiments of managing a plurality of types of L2P mapping by combining the mapping table 400 of FIG. 5A or the mapping tables MTS of FIG. 5B is also within the scope of the present disclosure. For example, the FTL block 240 and the mapping control block 250 of FIG. 2 may manage address mapping between logical addresses and physical addresses through the plurality of mapping tables MTS and the map differentiation region 410.

In one or more embodiments, a location at which data corresponding to the first type mapping entry is stored and a location at which data corresponding to the second type mapping entry is stored may be physically separated from each other. For example, referring to FIG. 4, when data corresponding to the first type mapping entry is stored in the first logical area LU1, data corresponding to the second type mapping entry may not be stored in the first logical area LU1. In one or more embodiments, on the basis of a channel, a way, a plane, or a chip, a location at which data corresponding to the first type mapping entry is stored and a location at which data corresponding to the second type mapping entry is stored may be different from each other, and may be physically separated from each other.

In FIGS. 5A and 5B, it was described that the mapping table 400 or the mapping tables MTS include these two types of mapping regions, but the scope of the present disclosure is not limited thereto. In one or more embodiments, the mapping table 400 may further include mapping regions including mapping entries corresponding to sizes other than the first capacity or the second capacity. In this case, a map differentiation region 510 may further manage mapping types other than the first type or second type of a logical address. In FIGS. 5A and 5B, and the following drawings, it is described that a data size indicated by the first type mapping entry is smaller than a data size indicated by the second type mapping entry, but the present disclosure should not be understood to be limited thereto.

Hereinafter, for convenience of description, it is described that the FTL block 240 and the mapping control block 250 of FIG. 2 manage address mapping based on the mapping table described through FIG. 5A, but the scope of the present disclosure is not limited thereto. It should be understood that embodiments described below may be similarly applied to the mapping tables MTS of FIG. 5B, without departing from the scope of the technical idea of the present disclosure.

FIG. 6 is a block diagram showing in detail the mapping table of FIG. 5A, according to one or more embodiments of the present disclosure. A mapping table 500 may correspond to the mapping tables of FIGS. 2 and 5A. Referring to FIG. 6, the mapping table 500 may include the map differentiation region 510, a first type mapping region 520, and a second type mapping region 530. The mapping table according to one or more embodiments of the present disclosure will be described in detail with reference to FIGS. 1 to 6.

The map differentiation region 510 may correspond to the map differentiation region 410 of FIG. 5A. In one or more embodiments, the map differentiation region 510 may include mapping types corresponding to a plurality of logical addresses. For example, the map differentiation region 510 may include mapping types for each of four logical addresses. In one or more embodiments, the map differentiation region 510 may be implemented as a bitmap, and each bit within the bitmap may indicate mapping types of a plurality of logical addresses.

In FIG. 6, the bitmap of the map differentiation region 510 may include the bits “1001”. The most significant bit (MSB) may indicate mapping types of LPN1 to LPN4. Bits may sequentially indicate mapping types of LPN5 to LPN8, LPN9 to LPN12, and LPN13 to LPN16, respectively. In one or more embodiments, bits of each bitmap of the map differentiation region 510 may indicate physical addresses of the corresponding logical addresses and the mapping regions 520 and 530 where a mapping entry is generated or stored. For example, when the bit of the map differentiation region 510 has a logical value of “1”, it may indicate that mapping entries of the corresponding logical addresses are stored in the first type mapping region 520.

In one or more embodiments, the number of logical addresses indicated by one bit of the map differentiation region 510 may be the ratio (or the maximum value of a size ratio) between a size of data indicated by the first type mapping entry and a size of data indicated by the second type mapping entry. In FIG. 6, data indicated by the first type mapping entry may have a size of 4 KB, and data indicated by the second type mapping entry may have a size of 16 KB, and thus one bit of the map differentiation region 510 may indicate the mapping type of four logical addresses.

The first type mapping region 520 may correspond to the first type mapping region 420 of FIG. 5A. The first type mapping region 520 may include first type mapping entries. For example, the first type mapping entry may indicate data with a size or capacity of 4 KB. The first type mapping entries may map LPN1 onto PPNa1, may map LPN2 onto PPNa2, and may map LPN3 and LPN4. Because each of the second and third high-order bits of the map differentiation region 510 is “0”, the first type mapping region 520 may not include mapping entries for LPN5 to LPN12. The first type mapping region 520 may include mapping entries for each of LPN13 to LPN16.

The second type mapping region 530 may correspond to the second type mapping region 430 of FIG. 5A. The second type mapping region 530 may include second type mapping entries. For example, the second type mapping entry may indicate data with a size of 16 KB. The second type mapping entries may map LPN5 to LPN8 onto PPNb1 and may map LPN9 to LPN12 onto PPNb2. In one or more embodiments, sizes of data pointed to by the physical address of the first type mapping region 520 and the physical address of the second type mapping region 530 may be different from each other. For example, PPNa2 of a first mapping entry M1 may indicate data with a size or capacity of 4 KB, and PPNb2 of a second mapping entry M2 may indicate data with a size or capacity of 16 KB. In one or more embodiments, a size of the first type mapping entry of the first type mapping region 520 may be (e.g., substantially) the same as a size of the second type mapping entry of the second type mapping region 530. For example, both the first mapping entry M1 and the second mapping entry M2 may have a size or capacity of 4 bytes.

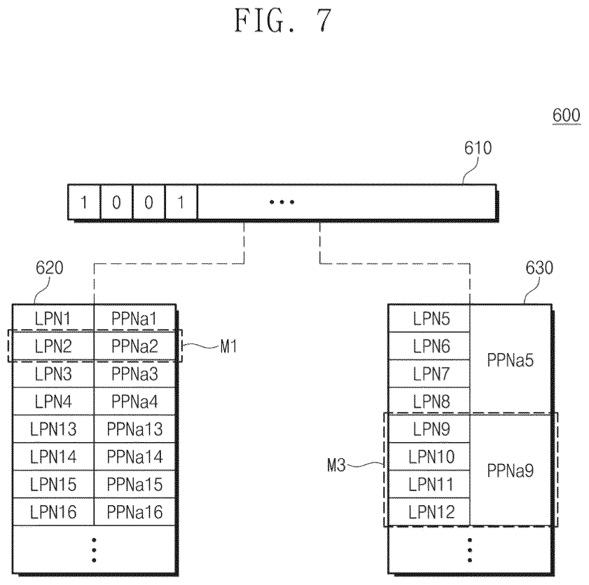

FIG. 7 is a block diagram showing in detail an example of the mapping table of FIG. 5A, according to one or more embodiments of the present disclosure. A mapping table 600 may correspond to the mapping tables of FIGS. 2 and 5A. Referring to FIG. 7, the mapping table 600 may include a map differentiation region 610, a first type mapping region 620, and a second type mapping region 630. The mapping table according to one or more embodiments of the present disclosure will be described in detail with reference to FIGS. 1 to 7.

The map differentiation region 610 may indicate the mapping type of logical addresses. The map differentiation region 610 may be identical to the map differentiation region 510 of FIG. 6. The first type mapping region 620 may include one or more first type mapping entries. The first type mapping region 620 may be identical to the first type mapping region 520 of FIG. 6.

The second type mapping region 630 may include one or more second type mapping entries. In one or more embodiments, a second type mapping entry within the second type mapping region 630 may map a physical address starting from one or more consecutive physical addresses corresponding to logical addresses. For example, the second type mapping entry may include PPNa5, which is a physical page number starting from the consecutive physical page numbers corresponding to LPN5 to LPN8.

In FIG. 7, the second type mapping region 630 may map LPN5 to LPN8 onto PPNa5 and may map LPN9 to LPN12 onto PPNa9. In one or more embodiments, a size of data indicated by a physical address included in the first type mapping entry may be the same as a size of data indicated by a physical address included in the second type mapping entry. For example, a data size indicated by a physical address (i.e., PPNa2) included in the first mapping entry M1 may be the same as a data size indicated by a physical address (or physical page number, i.e., PPNa9) included in a third mapping entry M3.

In one or more embodiments, a size of the first type mapping entry of the first type mapping region 620 may be (e.g., substantially) the same as a size of the second type mapping entry of the second type mapping region 630. For example, both the first mapping entry M1 and the third mapping entry M3 may have a size of 4 bytes.

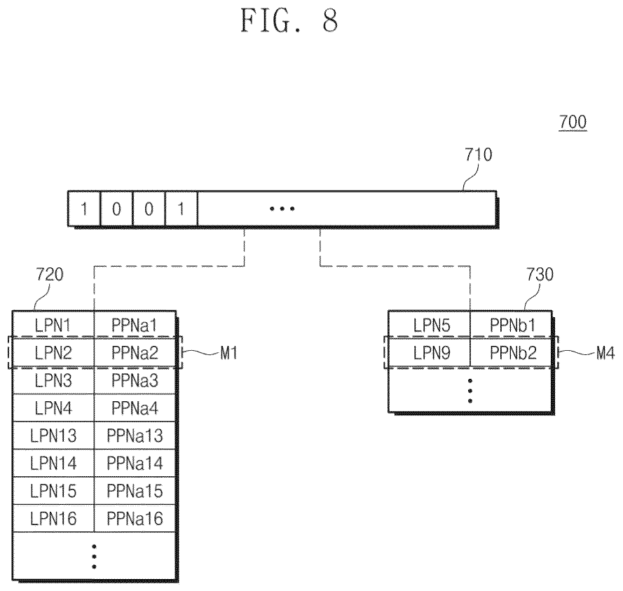

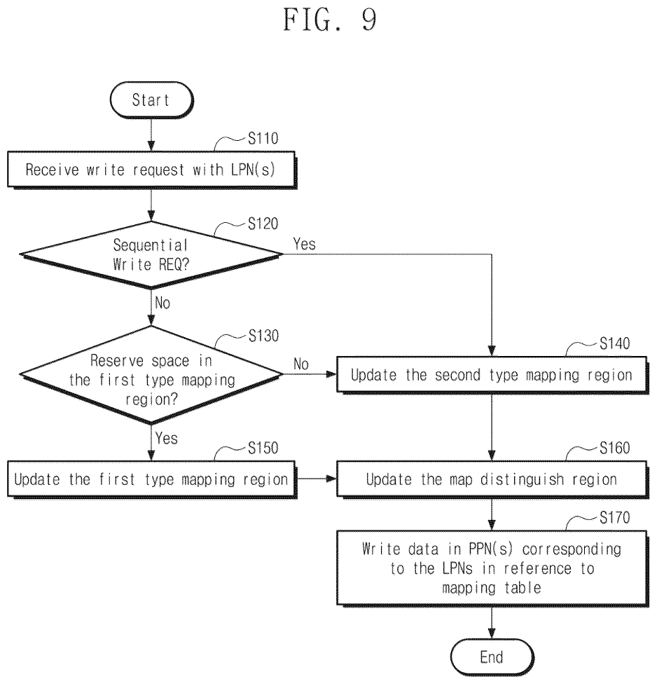

FIG. 8 is a block diagram showing in detail an example of the mapping table of FIG. 5A, according to one or more embodiments of the present disclosure. A mapping table 700 may correspond to the mapping tables of FIGS. 2 and 5A. Referring to FIG. 8, the mapping table 700 may include a map differentiation region 710, a first type mapping region 720, and a second type mapping region 730. The mapping table according to one or more embodiments of the present disclosure will be described in detail with reference to FIGS. 1 to 8.

The map differentiation region 710 may indicate the mapping type of logical addresses. The map differentiation region 710 may be identical to the map differentiation region 510 of FIG. 6 or the map differentiation region 610 of FIG. 7. The first type mapping region 720 may include one or more first type mapping entries. The first type mapping region 720 may be identical to the first type mapping region 520 of FIG. 6 or the first type mapping region 620 of FIG. 7.

The second type mapping region 730 may include one or more second type mapping entries. In one or more embodiments, a second type mapping entry within the second type mapping region 730 may map a logical address starting from consecutive logical addresses onto a physical address. For example, the second mapping entry may map LPN5 being the logical page number starting from LPN5 to LPN8 onto PPNb1 being the corresponding physical page number.

In one or more embodiments, a size of data indicated by the physical address of the first type mapping region 720 may be different from a size of data indicated by the physical address of the second type mapping region 730. For example, a size of data indicated by the physical address of the first type mapping region 720 may be 4 KB, and a size of data indicated by the physical address of the second type mapping region 730 may be 16 KB.

In one or more embodiments, a size of the first type mapping entry of the first type mapping region 720 may be (e.g., substantially) the same as a size of the second type mapping entry of the second type mapping region 530. For example, both the first mapping entry M1 and a fourth mapping entry M4 may have a size or capacity of 4 bytes.

It is described that the physical address included in the second type mapping entry of FIG. 8 is identical or similar to the second type mapping region 530 of FIG. 6, but the scope of the present disclosure is not limited thereto. In one or more embodiments, it is described that the physical address included in the second type mapping entry of FIG. 8 is identical or similar to the second type mapping region 630 of FIG. 7, but the scope of the present disclosure is not limited thereto.

The configurations of the mapping table illustrated and described in detail in FIGS. 6 to 8 are examples and the scope of the present disclosure is not limited thereto. It should also be understood that one or more embodiments, in which mapping entries described through FIGS. 6 to 8 are combined, are within the scope of the present disclosure. In FIGS. 6 to 8, it is described that a size of the first type mapping entry is the same as a size of the second type mapping entry, but the scope of the present disclosure is not limited thereto. For example, it should be understood that one or more embodiments, in which the length of the first type mapping entry is shorter than 4 bytes and the length of the second type mapping entry is 4 bytes, is also within the scope of the present disclosure. In FIGS. 6 to 8, only 16 logical addresses and mapping entries thereof are described, but it should be understood that the mapping table may further include mapping entries identical or similar to those described above.

In FIGS. 6 to 8, a mapping table including two types of L2P mapping is described, but this is an example. It should be understood that one or more embodiments further including an additional type(s) of L2P mapping is also within the scope of the present disclosure. In one or more embodiments, a mapping entry corresponding to the additional type may include mapping between one or more logical addresses and one or more physical addresses in a form identical or similar to that described through FIGS. 6 to 8. In one or more embodiments, the size of the mapping entry corresponding to the additional type may be (e.g., substantially) the same as sizes of the first or second type mapping entries.

In FIGS. 5A to 8, a ratio between a size of data indicated by the first mapping entry and a size of data indicated by the second mapping entry is an example. It should be understood that embodiments in which these ratios have different values are also within the scope of the present disclosure. For example, the size of the data indicated by the first type mapping entry may be 4 KB, and the size of the data indicated by the second type mapping entry may be 32 KB. In this case, each of bits of a map differentiation region may indicate the mapping type of 8 logical addresses. In one or more embodiments, the mapping table may further include one or more additional mapping regions, such as a third type mapping region. For example, the third type mapping region may manage third type L2P mapping through the third type mapping entry, and the third type mapping entry may indicate or correspond to data having the third capacity.

It is described that one bit in a bitmap of a map differentiation region indicates a mapping type of a plurality of logical addresses, but the scope of the present disclosure is not limited thereto. It should be understood that one or more embodiments in which a plurality of bits (e.g., two bits) indicate a mapping type of a plurality of logical addresses is also within the scope of the present disclosure. For example, the mapping table 500 may further include the third type mapping region. The third type mapping entry may indicate data with a size or capacity of 64 KB, and each of the two bits in the bitmap of the map differentiation region 510 may indicate the mapping type of the corresponding 16 logical addresses (because the ratio between 4 KB to 64 KB is 16). For example, when a value of bits corresponding to logical addresses in the bitmap is “00”, the logical addresses may be managed as the first type mapping entry. When the value of bits is “01”, the logical addresses may be managed as the second type mapping entry. When the value of bits is “10”, the logical addresses may be managed as the third type mapping entry, but this is an example and the present disclosure is not limited thereto. Even in this case, a ratio between the number of specific type mapping entries and the number of all allocable mapping entries may be managed so as not to exceed a threshold value.

It is described that the map differentiation region is implemented as a bitmap structure, but this is an example and it should be understood that one or more embodiments implemented as a data structure other than a bitmap is also within the scope of the present disclosure. In one or more embodiments, locations, at which pieces of data respectively corresponding to a plurality of types of mapping entries are stored, may be physically separated from each other. For example, a first location where data corresponding to the first type mapping entry is stored, a second location where data corresponding to the second type mapping entry is stored, or a third location where data corresponding to the third type mapping entry is stored may be physically separated from each other. For example, on the basis of a channel, a way, a plane, or a chip, the first location, the second location, and the third location may be different from each other, and may be physically separated from each other.

The mapping table of FIGS. 5A to 8 may increase the usage efficiency of the limited memory space within the buffer memory block 260 of FIG. 2 such that a significant amount of data is to be written to or read from a non-volatile memory device included in a storage device. Moreover, the mapping table 400 of FIGS. 5A to 8 determines mapping types based on factors such as the access type of data, thereby providing a storage device having high efficiency of data write or data read by using the limited memory capacity of the buffer memory block 260.

FIG. 9 is a flowchart showing an example of a data write operation method of the storage device of FIG. 1, according to one or more embodiments of the present disclosure. An example of a data write operation method of a storage device is described with reference to FIGS. 1 to 9.

In operation S110, the storage device 100 may receive a write request. In one or more embodiments, the write request may include logical addresses managed by the host 11 of FIG. 1. For example, the storage device 100 may receive the request REQ, which includes the logical addresses and indicates a write operation, through the host interface block 210.

In operation S120, the storage device 100 may determine the next operation based on the request REQ. In one or more embodiments, the storage device 100 may determine the next operation based on the type of an operation indicated by the request REQ. For example, the storage device 100 may determine the next operation based on whether the write request REQ indicates sequential write. In one or more embodiments, the storage device 100 may identify a type of an operation indicated by the request REQ and may identify the next operation through the mapping control block 250. For example, when receiving the request REQ indicating sequential write, the storage device 100 may proceed to operation S140. On the other hand, when not receiving the request REQ indicating sequential write (e.g., when receiving the request REQ indicating random write), the storage device 100 may proceed to operation S130.

In operation S130, the storage device 100 may identify the next operation based on whether there is reserve space in the first type mapping region 420. In one or more embodiments, the storage device 100 may identify the next operation based on whether the number of first type mapping entries exceeds a threshold value. For example, when the number of first type mapping entries is equal to the threshold value, the storage device 100 may determine that there is no reserve space in the first type mapping region 420 and may proceed to operation S140. For another example, when the number of first type mapping entries is less than the threshold value, the storage device 100 may determine that there is reserve space in the first type mapping region 420 and may proceed to operation S150.

In one or more embodiments, the storage device 100 may determine whether there is reserve space in the first type mapping region 420, through the mapping control block 250 or the FTL block 240. It is described in operation S130 that the next operation is identified based on the number of first type mapping entries, but the scope of the present disclosure is not limited thereto. For example, the storage device 100 may perform operation S130 based on a comparison between the ratio of the number of first type mapping entries to the number of all allocable mapping entries and a threshold value.

In operation S140, the storage device 100 may update the second type mapping region 430. In one or more embodiments, the FTL block 240 may generate a second type mapping entry (e.g., the second type mapping entry of FIGS. 6 to 8) including a relationship between the received logical addresses and one or more physical addresses. For example, the storage device 100 may update the second type mapping region 430 by adding the created second type mapping entry to the second type mapping region 430.

In operation S150, the storage device 100 may update the first type mapping region 420. In one or more embodiments, the FTL block 240 may generate a first type mapping entry (e.g., the first type mapping entry of FIGS. 6 to 8) including a relationship between received logical addresses and one or more physical addresses. For example, the storage device 100 may update the second type mapping region 430 by adding the generated first type mapping entry to the second type mapping region 430. The storage device 100 may proceed to operation S160 after operation S140 or operation S150.

In one or more embodiments, the size or capacity of data indicated by the second type mapping entry may be greater than the size or capacity of data indicated by the first type mapping entry. For example, the first type mapping entry may indicate data with a size of 4 KB, and the second type mapping entry may indicate data with a size of 16 KB. However, this is an example and the scope of the present disclosure is not limited thereto.

In operation S160, the storage device 100 may update the map differentiation region. In one or more embodiments, the FTL block 240 or the mapping control block 250 may update the map differentiation region 410 corresponding to logical addresses included in the request REQ. For example, the FTL block 240 or the mapping control block 250 may update bits corresponding to logical addresses of a bitmap within the map differentiation region 410.

In operation S170, the storage device 100 may write data to physical addresses corresponding to logical addresses with reference to the mapping table 400. In one or more embodiments, the storage controller 200 may transmit physical addresses and data, which are generated with reference to the mapping table 400 stored in the buffer memory block 260, to the non-volatile memory device 300 through the memory interface block 220.

The operation of the storage device 100 described through FIG. 9 is an example and the scope of the present disclosure is not limited thereto. In one or more embodiments, at least some of the operations of FIG. 9 may be performed simultaneously. In one or more embodiments, at least some of the operations of FIG. 9 may be performed in a changed order. In FIG. 9, it is described that two types of mapping entries are managed, but this is an example. It should be understood that one or more embodiments of writing data to the non-volatile memory device 300 by updating or referencing the mapping table 400 including and managing mapping entries of additional types is also within the scope of the present disclosure.

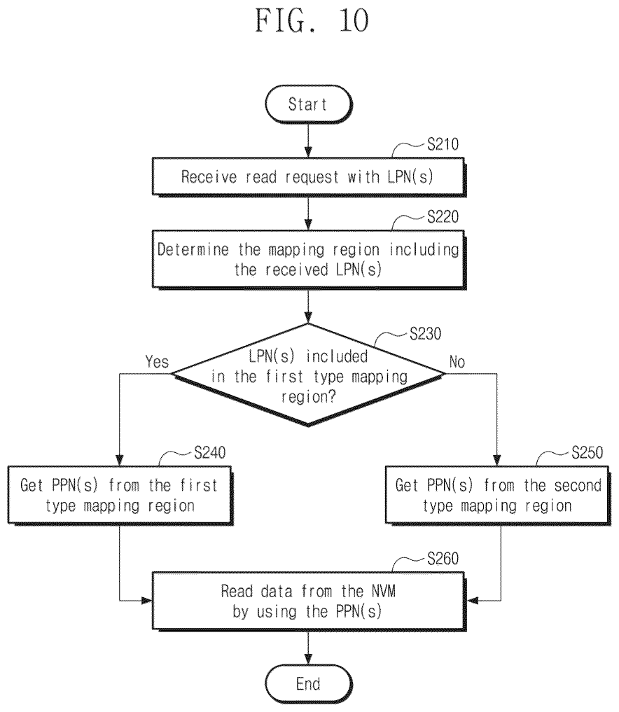

FIG. 10 is a flowchart showing an example of a data read operation method of the storage device of FIG. 1, according to one or more embodiments of the present disclosure. A method for reading data of the storage device 100 according to one or more embodiments of the present disclosure is described with reference to FIGS. 1 to 8 and 10.

In operation S210, the storage device 100 may receive a read request. In one or more embodiments, the read request may include logical addresses managed by the host 11 of FIG. 1. For example, the storage device 100 may receive the request REQ, which includes the logical addresses and indicates a read operation, through the host interface block 210.

In operation S220, the storage device 100 may determine a mapping region corresponding to the received logical addresses. In one or more embodiments, the FTL block 240 or the mapping control block 250 may determine the mapping region corresponding to logical addresses with reference to the map differentiation region 410. For example, when a value of a bit corresponding to the logical addresses of the bitmap in the map differentiation region 410 is logical 1, the storage controller 200 may determine that the mapping entry between a logical address and a physical address is included in the first type mapping region 420. For another example, when the value of the bit corresponding to the logical addresses of the bitmap in the map differentiation region 410 is logical 0, the storage controller 200 may determine that the mapping entry between a logical address and a physical address is included in the second type mapping region 430.

In operation S230, the storage device 100 may determine the next operation based on the determination in operation S220. When it is determined that the mapping entry of the logical address is included in the first type mapping region in operation S220, the storage device 100 may proceed to operation S240. When it is determined that the mapping entry of the logical address is included in the second type mapping region in operation S220, the storage device 100 may proceed to operation S250.

In operation S240, the storage device 100 may get physical addresses corresponding to logical addresses with reference to the first type mapping region 420. For example, the storage device 100 may get physical addresses corresponding to logical addresses based on one or more first type mapping entries corresponding to the logical addresses. In operation S250, the storage device 100 may get physical addresses corresponding to the logical addresses with reference to the second type mapping region 430. For example, the storage device 100 may get physical addresses corresponding to the logical addresses based on one or more second type mapping entries corresponding to the logical addresses. The storage device 100 may terminate operation S240 or operation S250 and then may proceed to operation S260.

In operation S260, the storage device 100 may read data from the non-volatile memory device 300 by using the obtained physical addresses. In one or more embodiments, through the memory interface block 220, the storage controller 200 may transmit commands and logical addresses to the non-volatile memory device 300 and may receive data from the non-volatile memory device 300. After operation S260, the storage device 100 may deliver the read data to the host 11 of FIG. 1.

The operation of the storage device 100 described through FIG. 10 is an example and the scope of the present disclosure is not limited thereto. In one or more embodiments, at least some of the operations of FIG. 10 may be performed simultaneously. In one or more embodiments, at least some of the operations of FIG. 10 may be performed in a changed order. In FIG. 10, it is described that two types of mapping entries are managed, but this is an example. It should be understood that one or more embodiments of reading data from the non-volatile memory device 300 by updating or referencing the mapping table 400 including and managing mapping entries of additional types is also within the scope of the present disclosure.

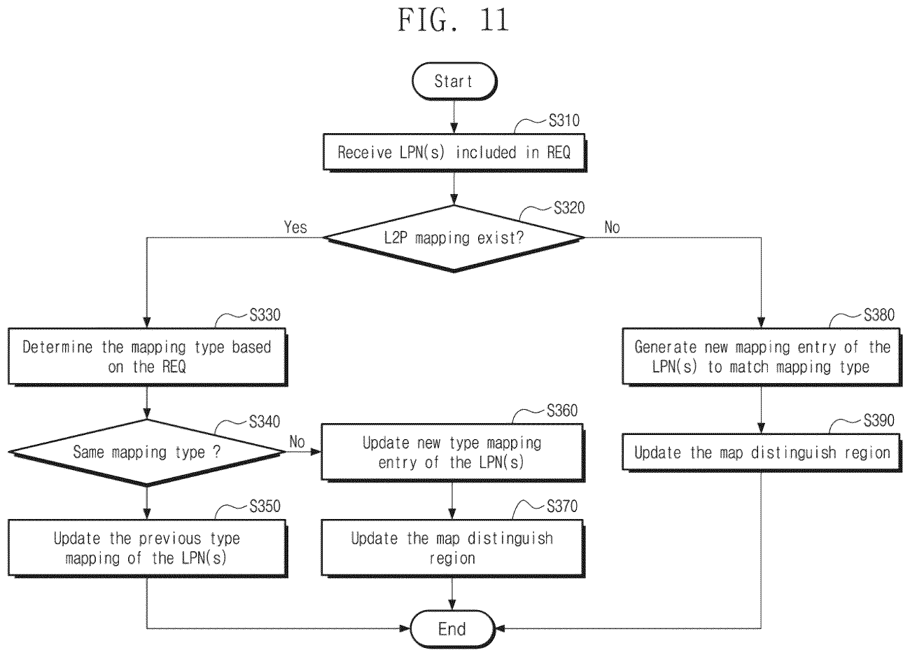

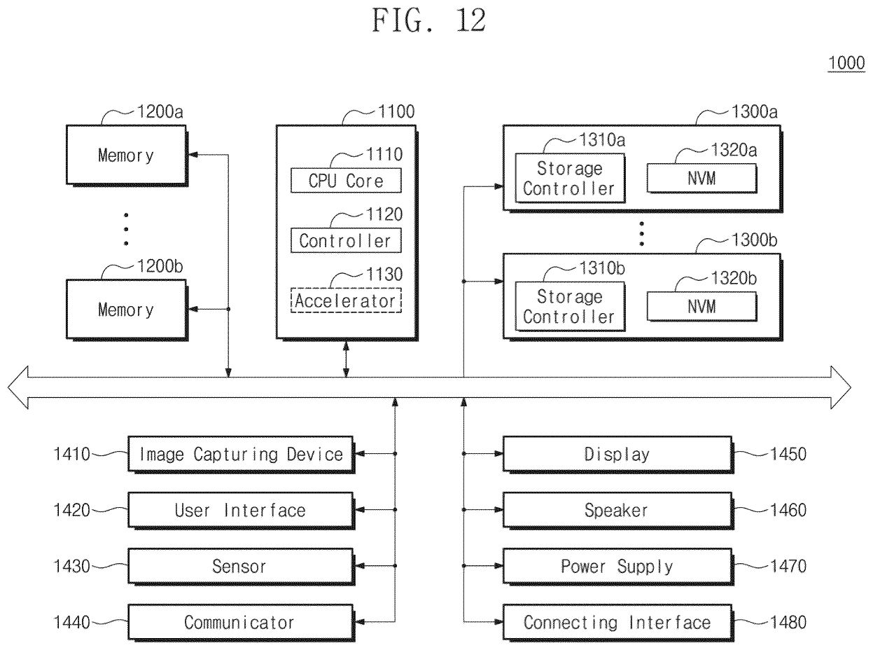

FIG. 11 is a flowchart showing an example of a mapping table update operation method of the storage controller of FIG. 2, according to one or more embodiments of the present disclosure. A method of updating the mapping table 400 is described in detail with reference to FIGS. 2 to 8 and 11.

In operation S310, the storage controller 200 may receive logical addresses included in the request REQ received from the host 11 of FIG. 1. In operation S320, the storage controller 200 may determine whether L2P mapping of a logical address exists, with reference to the mapping table 400. In one or more embodiments, the storage controller 200 may determine whether there is existing L2P mapping (or an existing mapping entry) of the received logical address, through the FTL block 240. When the existing L2P mapping (or an existing mapping entry) of the logical address received in operation S320 is present, the storage controller 200 may proceed to operation S330. On the other hand, when there is no existing L2P mapping (or the existing mapping entry) of the logical address received in operation S320, the storage controller 200 may proceed to operation S380.

In operation S330, the storage controller 200 may determine the mapping type of the received logical address or the type of the mapping entry of the received logical address based on the request REQ. The storage controller 200 may perform operation S330 identical to or similar to operation S120 of FIG. 9 or operation S220 of FIG. 10. In one or more embodiments, the storage controller 200 may perform operation S330 through the mapping control block 250.

In one or more embodiments, the storage controller 200 may determine the mapping type of the received logical address or the type of the corresponding mapping entry based on the type of an operation indicated by the request. For example, when receiving the request REQ indicating a sequential operation, the storage controller 200 may determine to generate a second type mapping entry within the second type mapping region 430 including the received logical address based on the request REQ. For another example, when receiving the request REQ indicating a random operation, the storage controller 200 may determine to generate a first type mapping entry within the first type mapping region 420 including the received logical address based on the request REQ.

In operation S340, the storage controller 200 may determine whether the type of the mapping entry determined in operation S330 is the same as the type of the existing mapping entry of the logical address. In one or more embodiments, the storage controller 200 may perform operation S340 through the mapping control block 250. In one or more embodiments, the storage controller 200 may determine the type of an existing mapping entry of a logical address with reference to the map differentiation region 410 in the mapping table 400, and may determine whether it is the same as the type of the mapping entry determined in operation S330.

When determining that the type of the mapping entry determined in operation S330 is the same as the type of the existing mapping entry, the storage controller 200 may proceed to operation S350. When determining that the type of the mapping entry determined in operation S330 is not the same as the type of the existing mapping entry, the storage controller 200 may proceed to operation S360.

In operation S350, the storage controller 200 may update the previous type of a mapping entry. In one or more embodiments, the storage controller 200 may update the previous type of the mapping entry through the FTL block 240. For example, the storage controller 200 may change a physical address(es) in the mapping entry corresponding to a logical address(es) to a new physical address(es) where data is to be written. After operation S350, the storage controller 200 may terminate an L2P mapping update operation.

In operation S360, the storage controller 200 may generate or update a new type of a mapping entry. In one or more embodiments, the storage controller 200 may update the new type of the mapping entry through the FTL block 240. For example, the storage controller 200 may generate the new type of the mapping entry including a mapping relationship between the logical address(es) and the physical address(es) where data is to be written.

In operation S360, the storage controller 200 may generate the new type of the mapping entry and may remove the existing mapping entry. The mapping entry generated in operation S350 and operation S360 may be stored in the corresponding mapping regions 420 and 430.

In operation S370, the storage controller 200 may update the map differentiation region. In one or more embodiments, the storage controller 200 may perform operation S370 through the FTL block 240 or the mapping control block 250. For example, the storage controller 200 may update the mapping type (or type of the mapping entry) of the logical address received in operation S310 within the map differentiation region 410 so as to be changed into a new type. For example, the FTL block 240 may change a value of bits of a portion corresponding to the received logical address(es) from among bits of the bitmap within the map differentiation region 410 so as to match the new type. After operation S370, the storage controller 200 may terminate an L2P mapping update operation.

In operation S380, the storage controller 200 may generate a new mapping entry. In one or more embodiments, the storage controller 200 may generate a new mapping entry of a logical address based on operations identical or similar to operations S120 to S150. For example, the storage controller 200 may generate a mapping entry of the first type or a mapping entry of the second type based on whether the request REQ indicates a sequential operation or a random operation.

In operation S390, the storage controller 200 may update the map differentiation region 410. In one or more embodiments, the storage controller 200 may update a portion corresponding to the received logical address(es) of the map differentiation region 410. The storage controller 200 may perform operation S390 in the identical or similar method to the method in operation S370. For example, when the map differentiation region 410 includes a bitmap indicating the type of a mapping entry, the type of the mapping entry indicated by the logical address(es) may be updated by updating the value of the bit corresponding to the logical address(es) from among the bits in the bitmap.

The operation of the storage controller 200 described through FIG. 11 is an example and the scope of the present disclosure is not limited thereto. In one or more embodiments, at least some of the operations of FIG. 11 may be performed simultaneously. In one or more embodiments, at least some of the operations of FIG. 11 may be performed in a changed order.

FIG. 12 is a diagram showing a system 1000 to which a storage device according to one or more embodiments of the present disclosure is applied. Basically, a system 1000 of FIG. 12 may be a mobile system such as a mobile phone, a smartphone, a tablet personal computer (PC), a wearable device, a health care device, or an Internet of things (IOT) device.

However, the system 1000 of FIG. 12 is not limited to the mobile system. For example, the system 1000 may be a system such as a personal computer, a laptop computer, a server, a media player, or an automotive device such as a navigation device.

Referring to FIG. 12, the system 1000 may include a main processor 1100, memories 1200a and 1200b, and storage devices 1300a and 1300b, and may further include one or more of an image capturing device 1410, a user input device 1420, a sensor 1430, a communicator 1440, a display 1450, a speaker 1460, a power supply 1470, and a connecting interface 1480.

The main processor 1100 may control overall operations of the system 1000 and, in more detail, may control operations of the remaining components of the system 1000 implementing the system 1000. The main processor 1100 may be implemented with a general-purpose processor, a special-purpose processor, or an application processor.

The main processor 1100 may include one or more CPU cores 1110, and may further include a controller 1120 for controlling the memories 1200a and 1200b and/or the storage devices 1300a and 1300b. According to one or more embodiments, the main processor 1100 may further include an accelerator 1130 being a dedicated circuit for high-speed data computation such as artificial intelligence (AI) data computation. The accelerator 1130 may include a graphics processing unit (GPU), a neural processing unit (NPU), and/or a data processing unit (DPU) and may be implemented with a separate chip physically independent of any other component of the main processor 1100.

The memories 1200a and 1200b may be used as main memory devices of the system 1000. Each of the memories 1200a and 1200b may include volatile memories such as SRAM and/or DRAM, and may also include non-volatile memories such as a flash memory, PRAM and/or RRAM. The memories 1200a and 1200b may be implemented within the same package as the main processor 1100.

The storage devices 1300a and 1300b may function as non-volatile storage devices that store data regardless of whether power is supplied, and may have a storage capacity larger than the memories 1200a and 1200b. The storage devices 1300a and 1300b may include storage controllers 1310a and 1310b and non-volatile memories (NVM) 1320a and 1320b storing data under control of the storage controllers 1310a and 1310b. Each of the non-volatile memories 1320a and 1320b may include a flash memory of a two-dimensional (2D) structure or a vertical NAND (V-NAND) flash memory of a three-dimensional structure or may include a different kind of nonvolatile memory such as a PRAM and/or a RRAM.

The storage devices 1300a and 1300b may be included in the system 1000 in a state of being physically separated from the main processor 1100 or may be implemented within the same package as the main processor 1100. Moreover, the storage devices 1300a and 1300b may be detachably coupled to other components of the system 1000 through an interface such as the connecting interface 1480 to be described later by having a form such as a solid state device (SSD) or a memory card. Such the storage devices 1300a and 1300b may include a device to which the standard such as universal flash storage (UFS), embedded multi-media card (eMMC), or non-volatile memory express (NVMe) is applied, not limited thereto.

In one or more embodiments, each of the storage devices 1300a and 1300b may be or include the storage device 100 described with reference to FIGS. 1 to 11. In one or more embodiments, each of the storage controllers 1310a and 1310b may be or include the storage controller 110 described with reference to FIGS. 1 to 11. Each of the non-volatile memories 1320a and 1320b may be or include the non-volatile memory device 120 described with reference to FIGS. 1 to 11.

The image capturing device 1410 may photograph (or capture) a still image or a moving image and may include a camera, a camcorder, and/or a webcam.

The user input device 1420 may receive various types of data input by a user of the system 1000 and may include a touch pad, a keypad, a keyboard, a mouse, and/or a microphone.

The sensor 1430 may detect various types of physical quantities capable of being obtained from the outside of the system 1000 and may convert the detected physical quantities to electrical signals. The sensor 1430 may include a temperature sensor, a pressure sensor, an illumination sensor, a position sensor, an acceleration sensor, a biosensor, and/or a gyroscope sensor.

The communicator 1440 may transmit/receive signals to/from other devices outside the system 1000 according to various communication protocols. The communicator 1440 may be implemented to include an antenna, a transceiver, and/or a MODEM.

The display 1450 and the speaker 1460 may function as an output device that outputs visual information and auditory information to the user of the system 1000.

The power supply 1470 may appropriately convert a power supplied from a battery embedded in the system 1000 and/or an external power source so as to be supplied to each component of the system 1000.

The connecting interface 1480 may provide a connection between the system 1000 and an external device that is connected to the system 1000 and capable of exchanging data with the system 1000. The connecting interface 1480 may be implemented with various interfaces such as an Advanced Technology Attachment (ATA) interface, an Serial ATA (SATA) interface, an external SATA (e-SATA) interface, an Small Computer Small Interface (SCSI) interface, an Serial Attached SCSI (SAS) interface, a Peripheral Component Interconnection (PCI) interface, a PCI express (PCIe) interface, an NVM express (NVMe) interface, an IEEE 1394 interface, an Universal Serial Bus (USB) interface, an Secure Digital (SD) card interface, an Multi-Media Card (MMC) interface, an embedded Multi-Media Card (eMMC) interface, an Universal Flash Storage (UFS) interface, an embedded Universal Flash Storage (eUFS) interface, and a Compact Flash (CF) card interface.

The above description refers to detailed embodiments for carrying out the present disclosure. The present disclosure may include embodiments in which a design is changed simply or which are easily changed, as well as the embodiments described above. In addition, technologies that are easily changed and implemented by using the above embodiments may be included in the present disclosure. While the present disclosure has been described with reference to embodiments described above, it will be apparent to those of ordinary skill in the art that various changes and modifications may be made thereto without departing from the spirit and scope of the present disclosure as set forth in the following claims.

According to one or more embodiments of the present disclosure, a storage device for providing multiple L2P mapping may efficiently store data based on an efficient method of mapping between logical address and physical address and may efficiently manage storage space, and an operating method thereof are provided.

While the present disclosure has been described with reference to embodiments thereof, it will be apparent to those of ordinary skill in the art that various changes and modifications may be made thereto without departing from the spirit and scope of the present disclosure as set forth in the following claims.

1. A storage controller for controlling a non-volatile memory device, the storage controller comprising:
a memory storing one or more instructions; and
at least one processor configured to individually or collectively execute the one or more instructions,
wherein the one or more instructions, when executed by the at least one processor, cause the storage controller to:
based on a request received from a host indicating a sequential operation, identify a type of a mapping entry between a logical address included in the request and a physical address of the non-volatile memory device;
manage a first mapping table comprising one or more mapping entries of a first type; and
manage a second mapping table comprising one or more mapping entries of a second type,
wherein the one or more mapping entries of the first type correspond to data of a first capacity, and
wherein the one or more mapping entries of the second type correspond to data of a second capacity.

2. The storage controller of claim 1, wherein the second capacity is greater than the first capacity.

3. The storage controller of claim 2, wherein a ratio between the first capacity and the second capacity is a power of two.

4. The storage controller of claim 1, wherein a ratio of a maximum value of a number of the one or more mapping entries of the first type to a maximum value of a number of allocable mapping entries in the first mapping table and the second mapping table is less than a threshold value.

5. The storage controller of claim 1, wherein the one or more instructions, when executed by the at least one processor, cause the storage controller to:
manage a bitmap corresponding to one or more logical addresses, wherein the bitmap indicates a mapping type of the one or more corresponding logical addresses.

6. The storage controller of claim 5, wherein a value of each respective bit of the bitmap corresponds to an indication that one or more logical addresses corresponding to the respective bit is included in either a first type of mapping entries or a second type of mapping entries.

7. The storage controller of claim 5,
wherein the second capacity is greater than the first capacity, and
wherein a number of logical addresses corresponding to one bit of the bitmap corresponds to a ratio between the second capacity and the first capacity.

8. The storage controller of claim 5, wherein the one or more instructions, when executed by the at least one processor, cause the storage controller to:
load the first mapping table and the second mapping table and to store data.

9. A data write operation method of a storage controller, the method comprising:
receiving a request and one or more logical addresses from a host;
identifying, based on the request, a mapping type between the one or more logical addresses and one or more physical addresses of a non-volatile memory device of the storage controller;
generating a mapping entry between the one or more logical addresses and the one or more physical addresses;
updating a relationship between types of the mapping entry; and
writing data to a physical address included in the mapping entry.

10. The method of claim 9,
wherein the mapping entry is included in a plurality of mapping tables, and
wherein the plurality of mapping tables comprises:
a first mapping table comprising one or more mapping entries of a first type corresponding to data of a first capacity; and
a second mapping table comprising one or more mapping entries of a second type corresponding to data of a second capacity.

11. The method of claim 10, wherein the identifying the mapping type further comprises identifying the mapping type based on whether an operation indicated by the request is a sequential operation.

12. The method of claim 10, further comprising managing the first mapping table and the second mapping table.

13. The method of claim 12, wherein a number of the one or more mapping entries of the first type is less than a threshold value.

14. The method of claim 12,
wherein the managing the first mapping table and the second mapping table comprises:
managing a mapping type of the one or more logical addresses; and
managing a bitmap, and
wherein one bit of the bitmap indicates a type of a mapping entry comprising one or more corresponding logical addresses.

15. The method of claim 11,
wherein the second capacity is greater than the first capacity, and
wherein the identifying the mapping type further comprises identifying the mapping entry as the second type based on an operation indicated by the request being the sequential operation.

16. A storage device comprising:
a non-volatile memory device configured to store data; and
a storage controller configured to control the non-volatile memory device,
wherein the storage controller comprises:
a memory storing one or more instructions; and
at least one processor configured to individually or collectively execute the one or more instructions,
wherein the one or more instructions, when executed by the at least one processor, cause the storage controller to: receive a request and one or more logical addresses from a host; and
identify, based on the request, a type of a mapping entry between the one or more logical addresses and a physical address of the non-volatile memory device, and
wherein the mapping entry comprises a first type mapping entry corresponding to data of a first capacity and a second type mapping entry corresponding to data of a second capacity.

17. The storage device of claim 16,
wherein the one or more instructions, when executed by the at least one processor, further cause the storage controller to manage a plurality of mapping tables, and
wherein the plurality of mapping tables comprises:
a first mapping table comprising the first type mapping entry; and
a second mapping table comprising the second type mapping entry.

18. The storage device of claim 16,
wherein the first capacity is smaller than the second capacity, and
wherein the one or more instructions, when executed by the at least one processor, further cause the storage controller to, based on the request indicating a sequential operation, generate the second type mapping entry of the one or more logical addresses.

19. The storage device of claim 17, wherein a number of the first type mapping entry is less than a threshold value.

20. The storage device of claim 17, wherein the one or more instructions, when executed by the at least one processor, further cause the storage controller to load the first mapping table.

21-23. (canceled)
